(19) United States
(12) Patent Application Publication
(10) Pub. No.: US 2010/0162832 A1
(43) Pub. Date: Jul. 1, 2010

(54) SHEAR FORCE AND PRESSURE MEASUREMENT IN WEARABLE TEXTILES

(75) Inventor: Andreas Brauers, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/528,084

(22) PCT Filed: Feb. 20, 2008
(86) PCT No.: PCT/IB2008/050606

§ 371 Date: Mar. 8, 2010

(30) Foreign Application Priority Data
Feb. 23, 2007 (EP) 07102964.9

(51) Int. Cl. G01L 1/14

(52) U.S. Cl. 73/862.626

(57) ABSTRACT

The invention refers to a sensor arrangement comprising at least one capacitance sensor for detecting a pressure and a shear force, wherein the capacitance sensor is integrated into a wearable textile, a method for measuring a shear force and a pressure by such a sensor arrangement, wherein the shear force and pressure is exerted on a skin of a person lying in a bed or sitting in a chair and to combinations and uses of the method. This described textile sensors allow for a simultaneous measurement of shear stress and pressure in anti decubitus textiles. This enhances risk assessment with regard to the development of bedsore ulcer.

The invention refers to a sensor arrangement comprising at least one capacitance sensor for detecting a pressure and a shear force, wherein the capacitance sensor is integrated into a wearable textile, a method for measuring a shear force and a pressure by such a sensor arrangement, wherein the shear force and pressure is exerted on a skin of a person lying in a bed or sitting in a chair and to combinations and uses of the method.

The measurement of pressure or pressure profiles in beds is known in the art. An application of prime importance is the monitoring of persons who are at risk of developing a decubitus ulcer, also referred to as pressure ulcers or bedsore, lesions to any part of the body, especially portions over bony or cartilaginous areas. Causes for these bedsores are a combination of external factors, like pressure, friction, shear force, and moisture, and internal factors, e.g. fever, malnutrition, anaemia, and endothelial dysfunction. Pressure measurement can be used to monitor areas of high pressure load and to trigger a repositioning of the person. A more complete monitoring of the external factors would contribute to improve the situation by allowing more precise, individual pressure relief plans. One step into this direction would be to integrate shear force measurements and pressure measurements. In the patent application publication US 2005/0076715 A1 it is proposed to sense shear forces in a bed. However, the approach to sense shear forces in a bed by a bed integrated sensor will either require that the person is lying on the sensor naked or will not measure the shear forces acting actually on the skin.

It is thus an objective of the invention to provide a sensor arrangement and a method of measurement, that avoids the restrictions of the prior art.

The above mentioned objective is accomplished by a sensor arrangement comprising one or a plurality of capacitance sensors, the capacitance sensors being adapted for detecting a pressure and a shear force, wherein the capacitance sensors are integrated into a wearable textile.

An integration of the capacitance sensors into wearable textiles advantageously allows to measure a pressure and a shear force exerted on a skin portion of a person. The scope of applications of the present invention advantageously covers beds, wheelchairs and other surfaces. A capacitance sensor which is also referred to as a capacitive sensor, in the sense of the invention comprises a capacitor which is an electrical device that can store energy in the electric field between a pair of closely-spaced flat electrodes or conductors.

According to a preferred embodiment of the invention, the capacitance sensors comprise two capacitor electrodes isolated by a dielectric, wherein

the dielectric is compressibly elastic for allowing an alteration of a distance between the two electrodes, and/or
the dielectric is shearably elastic for allowing a displacement of at least one of the electrodes in a direction parallel to a plane of the electrode.

Advantageously, the capacitance sensors are used for measuring the shear force as well as for measuring the pressure. The pressure is measurable as a force acting in a normal direction onto the plane of the electrodes, by which force the dielectric is compressed and the distance between the electrodes is reduced. A resulting increase in capacitance of the sensor is measurable, preferably using suitable electronics as, for example, a bridge type circuit.

The shear force acting on the capacitance sensor displaces the electrodes in a direction parallel to a plane of the electrode which is a plane defined by the extension of the flat electrode. Thus, an overlap of the electrodes, the so-called effective area of the capacitor is reduced which results in a measurable reduction of capacitance of the sensor. According to the invention, one part of the capacitance sensors may be used for pressure measurement and another part for shear force measurement. However, it is also within the scope of the invention, that one or more capacitance sensor may be adapted to measure both pressure and shear force which requires a discrimination of the described effects.

According to the invention, it is preferred that at least a first capacitance sensor comprises the compressibly elastic dielectric, the electrodes of the first capacitance sensor being fixed to prevent the relative displacement of the electrodes in the direction parallel to the plane of the electrode. By preventing the displacement of the electrodes, the first capacitance sensor is advantageously utilisable for the measurement of pressure. To fix the electrodes, preferably a non-conductive structure is used which connects the electrodes, the structure preferably comprising fibres, in particular textile fibres.

According to the invention, it is also preferred that at least a second capacitance sensor comprises the shearably elastic dielectric, the electrodes of the second capacitance sensor being fixed to prevent the alteration of the distance between the two electrodes. By preventing that the distance of the electrodes is altered, the second capacitance sensor is advantageously utilisable for the measurement of shear forces. In a preferable embodiment, the electrodes are displaceable on the dielectric which is incompressible. The electrodes, for example are woven into a elastic textile which provides a restoring force. Another preferable embodiment comprises a dielectric which provides an anisotropic elasticity, like, for example, a honeycomb structure dielectric, which is incompressible but shearably elastic in the sense of the invention.

According to the invention, it is further preferred that the plurality of capacitance sensors is arranged in an array, the array preferably comprising an alternating arrangement of the first capacitance sensors and the second capacitance sensors. With a combination of first capacitance sensors measuring the pressure and second capacitance sensors measuring the shear forces in an array, the sensor arrangement is advantageously easily applicable. The array is advantageous for the integration into the wearable textile.

According to another preferred embodiment of the invention, at least one of the electrodes comprises a plurality of electrode stripes, the stripes being electrically isolated from one another. The electrode stripes are referred to as well as a comb-structure. Compared to an electrode with one continuous area, the comb-structured electrode comprises a plurality of sub-areas which advantageously provide for an enhanced resolution of the capacitance and thus of the measurement. In particular, this embodiment advantageously allows a measurement of both pressure and shear force by the same sensor.

More preferable, both electrodes comprise a plurality of electrically isolated electrode stripes. The stripes of the first electrode may advantageously extend substantially rectangularly with respect to the stripes of the second electrode which allows even a two-dimensional resolution of the capacitance. According to the invention, it is furthermore preferred that each electrode stripe comprises an electric contact which advantageously allows to query each single electrode stripe. In other words, each electrode stripe can be seen as a unique capacitor electrode.

According to a further preferred embodiment of the invention, the wearable textile is one of a nightgown, socks, underwear, a pyjama, a bed sheet or diapers. The sensor arrangement according to the invention is advantageously integrateable into any kind of wear which is worn on the skin, even comparably small pieces of clothing, like socks which may advantageously be used to prevent heel ulcers.

Another object of the present invention is a method for measuring a shear force and a pressure by a sensor arrangement according to the invention, the shear force and pressure being exerted on a skin of a person lying in a bed or sitting in a chair, wherein the person is wearing the wearable textile.

It is an advantage, that the sensor arrangement is substantially continuously in contact to the skin of the person and thus pressure and shear forces may continuously be measured.

Preferably, the pressure is measured by a sensor arrangement wherein at least the first capacitance sensor comprises the compressibly elastic dielectric, the electrodes of the first capacitance sensor being fixed to prevent the relative displacement of the electrodes in the direction parallel to the plane of the electrode. By preventing the displacement of the electrodes, the first capacitance sensor is advantageously utilisable for the measurement of pressure.

Furthermore preferred, the shear force is measured by a sensor arrangement wherein at least the second capacitance sensor comprises the shearably elastic dielectric, the electrodes of the second capacitance sensor being fixed to prevent the alteration of the distance between the two electrodes. By preventing that the distance of the electrodes is altered, the second capacitance sensor is advantageously utilisable for the measurement of shear forces.

In a preferred embodiment of the method according to the invention, the shear force and the pressure are measured by one or more sensors which are adapted to measure both the shear force and the pressure, in particular by a sensor arrangement wherein at least one of the electrodes comprises a plurality of electrode stripes, the stripes being electrically isolated from another. This advantageously allows a measurement of both pressure and shear force by the same sensor.

More preferably, the method comprises a step of determining an effective electrode area by detecting a capacitance of each electrode stripe, in particular of those electrode stripes which are located near the boundary of the electrode. It is advantageously possible to determine whether a stripe contributes to the effective area of the capacitor or not. The shear force is advantageously determined from the effective area of the capacitor.

Furthermore preferred, the pressure is then measured with regard to the effective electrode area. Knowing the effective area of the capacitor advantageously allows a discrimination of the shear force effects on the capacitance and the pressure effects.

Another object of the invention is a combination of the method according to the invention with one or more of an electromyography (EMG) by textile electromyography sensors, other vital body sign measurements and a humidity sensing. Additional EMG measurement is advantageously applicable for persons with spastic paraplegia. Humidity sensing is advantageous as humidity is an influencing factor for the development of bedsore ulcers.

Another object of the invention is a use of the method according to the invention for detecting a need of repositioning the person. Advantageously an individual repositioning plan for the person is obtained, which can be adapted in realtime. According to the use, it is furthermore preferred to supervise the repositioning which advantageously provides information whether the repositioning of the person has been done in a correct manner and not resulted in a position which would promoter the development of ulcers.

Another object of the invention is a use of the method according to the invention for surveillance of a person with spastic paraplegia. Causes for high pressure or shear loads and thus for recurrence of bedsores often lie in spastic movements, in particular for paraplegic persons. These movements also may advantageously be monitored using the sensor arrangement according to the invention.

Another object of the invention is a use of the method according to the invention for documentation of a repositioning of the person and/or for documentation of an adherence of the repositioning to a repositioning plan. The documentation of the proper repositioning and the adherence to the repositioning plan is advantageous for quality control and most beneficial for a verification of care quality.

These and other characteristics, features and advantages of the present invention will become apparent from the following detailed description, taken in conjunction with the accompanying drawings, which illustrate, by way of example, the principles of the invention. The description is given for the sake of example only, without limiting the scope of the invention. The reference figures quoted below refer to the attached drawings.

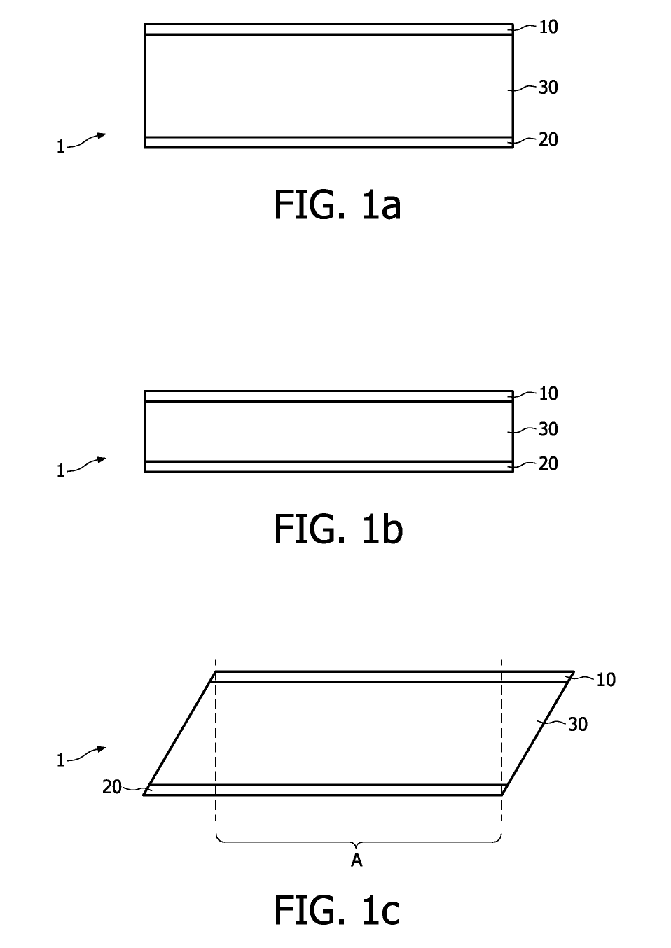

FIGS. 1a, 1b and 1c illustrates a measurement principle which used for the sensor arrangement according to the invention.

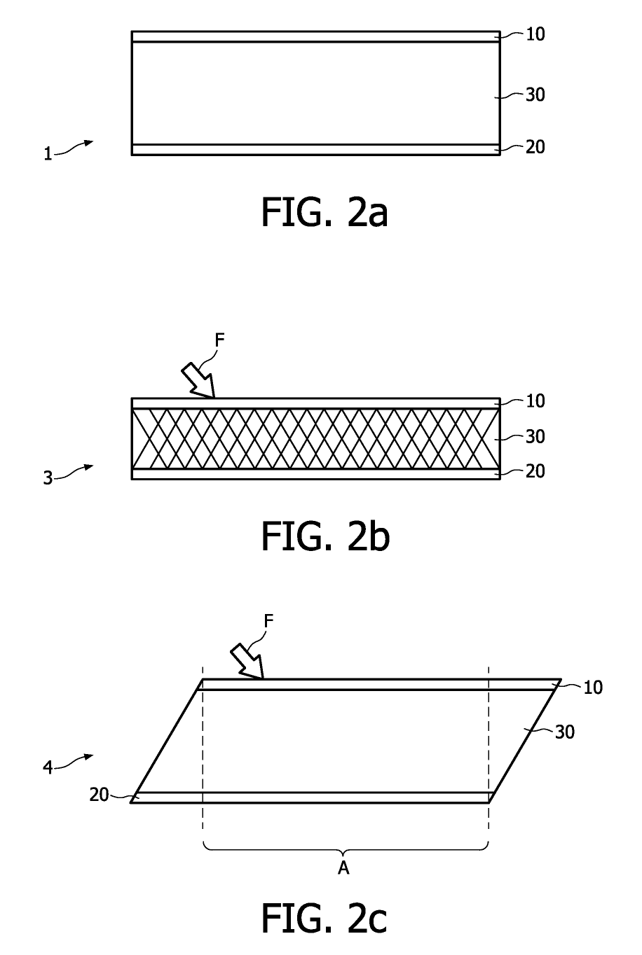

FIGS. 2a, 2b and 2c illustrate embodiments of capacitance sensors in the sensor arrangement according to the invention.

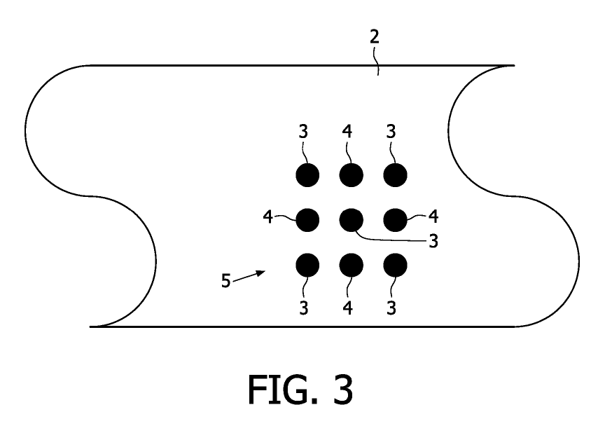

FIG. 3 schematically illustrates an application of the sensor arrangement according to the invention.

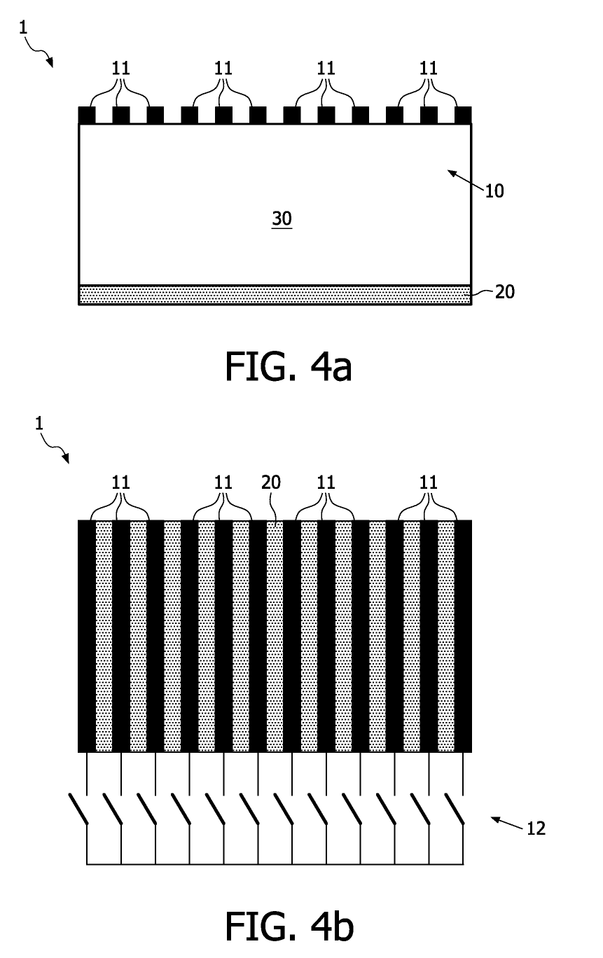

FIGS. 4a and 4b illustrate in different views another embodiment of a capacitance sensor of the sensor arrangement according to the invention.

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn true to scale for illustrative purposes.

Where an indefinite or definite article is used when referring to a singular noun, e.g. “a”, “an”, “the”, this includes a plural of that noun unless something else is specifically stated.

Furthermore, the terms first, second, third and the like in the description and in the claims are used for distinguishing between similar elements and not necessarily for describing a sequential or chronological order. It is to be understood that the terms so used are interchangeable under appropriate circumstances and that the embodiments of the invention described herein are capable of operation in other sequences than described or illustrated herein.

Moreover, the terms top, bottom, over, under and the like in the description and the claims are used for descriptive purposes and not necessarily for describing relative positions. It is to be understood that the terms so used are interchangeable under appropriate circumstances and that the embodiments of the invention described herein are capable of operation in other orientations than described or illustrated herein.

It is to be noticed that the term “comprising”, used in the present description and claims, should not be interpreted as being restricted to the means listed thereafter; it does not exclude other elements or steps. Thus, the scope of the expression “a device comprising means A and B” should not be limited to devices consisting only of components A and B. It means that with respect to the present invention, the only relevant components of the device are A and B.

In FIGS. 1a, 1b and 1c, a general capacitor or capacitance sensor 1 is depicted, which is utilisable for a sensor arrangement according to the invention. The capacitor and the capacitance sensor are equally referred to in here, although the person skilled in the art recognises that the capacitance sensor 1 comprises not only the capacitor but also respective connections etc. which are not depicted. The capacitance sensor 1 comprises two electrodes 10, 20 which extend generally parallel into a direction normal to the drawing plane. The electrodes 10, 20, in particular, textile electrodes 10, 20 are separated and electrically isolated by a dielectric 30. The capacitance sensor 1 depicted in FIG. 1a, is not loaded by any external forces. In FIG. 1b, a pressure acts upon the upper electrode 10, substantially in a direction normal to a plane of the electrode 10. As the dielectric 30 is elastic it is compressed and a distance between the electrodes 10, 20 is reduced, resulting in an increased capacitance of the capacitor 1. A different effect of shear forces are schematically illustrated in FIG. 1c. With a shear force acting on the capacitance sensor 1, the electrodes 10, 20 are displaced relative to each other in parallel planes, thus reducing an effective area A of the capacitor 1, by which the capacitance of the capacitor 1 is reduced.

In real life situations, the effects of normal pressure and shear stress will not exist in pure form. For example, due to a weight of a person in a bed, the mattress is deformed at contact areas, resulting in shear stress in these contact areas. Therefore, the effects are advantageously separated by embodiments of the sensor arrangement as referred to in FIGS. 2 and 4.

In FIGS. 2a, 2b and 2c, embodiments of capacitance sensors 1, 3, 4 of the sensor arrangement according to the invention are illustrated. FIG. 2a, again, depicts the general capacitance sensor 1 which is not loaded by any external forces. In FIGS. 2b and 2c, respectively, the capacitance sensors 3, 4 are loaded with both shear and pressure as illustrated by arrow F. In FIG. 2b, a “horizontal” displacement of the two electrodes 10, 20 relative to each other is prohibited. This is advantageously easily achieved, for example, by stitching techniques. The electrodes 10, 20 are preferably coupled by a non-conducting structure 31 of, for example, non conducting textile fibres. Thus, the capacitance sensor 3 is adapted for vertical force/pressure sensing, the relative position of the two electrodes 10, 20 being fixed. In FIG. 2c, a capacitance sensor 4 is depicted, which is, for example, equipped with an incompressible dielectric 30, in order to avoid compression in those areas where only shear shall be measured.

In FIG. 3, an array 5 of capacitance sensors 3, 4 for shear and pressure sensing is depicted which array is integrated into a wearable textile 2.

In FIGS. 4a and 4b, another embodiment of the capacitance sensor 1 is illustrated. The upper electrode 10 of this comprises a comb-like structure with electrode stripes 11 and a lower full electrode 20 (or vice versa).

FIG. 4a shows a schematic side view, FIG. 4b a schematic top view of the capacitance sensor 1 with the dielectric (30 in FIG. 4a) shown transparent in FIG. 4b for reasons of simplicity. To evaluate the different forces, the stripes 11 of the electrode 10 have to be evaluated in different modes via the connections 12. Shear stress will result in the outer electrode stripes 11 being displaced from the respective counter electrode 20. This is preferably checked by measuring the capacitance using the single outer electrode stripes. Having this information the effective area (ref. FIG. 1) of the sheared capacitor 1 can advantageously be calculated. Knowing the effective area, also the compression between the electrodes 10, 20 can be measured to evaluate the pressure. The embodiment may be used in different geometrical situations, e.g. bottom and top electrodes 10, 20 are comb-like structures with parallel electrode stripes, or comb-like structures with crossing electrode stripes. The embodiment is advantageously selectable according to the respective requirements, for example emerging from the respective manufacturing process.

1. Sensor arrangement comprising one or a plurality of capacitance sensors (1, 3, 4), the capacitance sensors being adapted for detecting a pressure and a shear force, wherein the capacitance sensors (1, 3, 4) are integrated into a wearable textile (2).

2. Sensor arrangement according to claim 1, wherein the capacitance sensors (1, 3, 4) comprise two capacitor electrodes (10, 20) isolated by a dielectric (30),
the dielectric (30) being compressibly elastic for allowing an alteration of a distance between the two electrodes (10, 20), and/or
the dielectric (30) being shearably elastic for allowing a displacement of at least one of the electrodes (10, 20) in a direction parallel to a plane (P) of the electrode.

3. Sensor arrangement according to claim 2, wherein at least a first capacitance sensor (3) comprises the compressibly elastic dielectric (30), the electrodes (10, 20) of the first capacitance sensor (3) being fixed to prevent the relative displacement of the electrodes (10, 20) in the direction parallel to the plane (P) of the electrode.

4. Sensor arrangement according to claim 3, wherein the electrodes (10, 20) are fixed by a non-conductive structure connecting the electrodes (10, 20), the structure (31) preferably comprising fibres, in particular textile fibres.

5. Sensor arrangement according to claim 2, wherein at least a second capacitance sensor (4) comprises the shearably elastic dielectric (30), the electrodes (10, 20) of the second capacitance sensor (4) being fixed to prevent the alteration of the distance between the two electrodes (10, 20).

6. Sensor arrangement according to claim 3, the plurality of capacitance sensors (1, 3, 4) being arranged in an array (5), the array preferably comprising an alternating arrangement of the first capacitance sensors (3) and the second capacitance sensors (4).

7. Sensor arrangement according to claim 2, wherein at least one of the electrodes (10) comprises a plurality of electrode stripes (11), the stripes being electrically isolated from another.

8. Sensor arrangement according to claim 2, wherein both electrodes (10, 20) comprise a plurality of electrode stripes (11), the stripes being electrically isolated from another.

9. Sensor arrangement according to claim 7, wherein each electrode stripe (11) comprises an electric contact (12).

10. Sensor arrangement according to claim 1, wherein the wearable textile (2) is one of a nightgown, socks, underwear, a pyjama, a bed sheet or diapers.

11. Method for measuring a shear force and a pressure by a sensor arrangement according to claim 1, the shear force and pressure being exerted on a skin of a person lying in a bed or sitting in a chair, wherein the person is wearing the wearable textile (2).

12. Method for measuring a shear force and a pressure by a sensor comprising one or a plurality of capacitance sensors (1, 3, 4), the capacitance sensors being adapted for detecting a pressure and a shear force, wherein the capacitance sensors (1, 3, 4) are integrated into a wearable textile (2), the shear force and pressure being exerted on a skin of a person lying in a bed or sitting in a chair, wherein the person is wearing the wearable textile (2), the pressure being measured by a sensor arrangement according to claim 3.

13. Method for measuring a shear force and a pressure by a sensor comprising one or a plurality of capacitance sensors (1, 3, 4), the capacitance sensors being adapted for detecting a pressure and a shear force, wherein the capacitance sensors (1, 3, 4) are integrated into a wearable textile (2), the shear force and pressure being exerted on a skin of a person lying in a bed or sitting in a chair, wherein the person is wearing the wearable textile (2), the shear force being measured by a sensor arrangement according to claim 5.

14. Method for measuring a shear force and a pressure by a sensor comprising one or a plurality of capacitance sensors (1, 3, 4), the capacitance sensors being adapted for detecting a pressure and a shear force, wherein the capacitance sensors (1, 3, 4) are integrated into a wearable textile (2), the shear force and pressure being exerted on a skin of a person lying in a bed or sitting in a chair, wherein the person is wearing the wearable textile (2), the shear force and the pressure being measured by a sensor arrangement according to claim 7.

15. Method according to claim 14, comprising a step of determining an effective electrode area (A) by detecting a capacitance of each electrode stripe (11).

16. Method according to claim 15, wherein the pressure is measured with regard to the effective electrode area (A).

17. Combination of a method according to claim 11 with one or more of a electromyography by textile electromyography sensors, other vital body sign measurements and a humidity sensing.

18. Use of a method according to claim 11 for detecting a need of repositioning the person and/or for supervision of a repositioning of the person.

19. Use of a method according to claim 11 for surveillance of a person with spastic paraplegia.

20. Use of a method according to claim 11 for documentation of a repositioning of the person and/or for documentation of an adherence of the repositioning to a repositioning plan.
